(19) United States
(12) Patent Application Publication
(10) Pub. No.: US 2005/0202825 A1
(43) Pub. Date: Sep. 15, 2005

(54) Systems and methods for transmitting data in a wireless communications network

(76) Inventors: Gagan Puranik, Madison, MS (US); Stephen M. Oshinsky, Jackson, MS (US)

Correspondence Address: MCI, INC, 1133 19TH STREET NW, WASHINGTON, DC, 20036, US

(21) Appl. No.: 10/796,133

(22) Filed: Mar. 10, 2004

(51) Int. Cl. H04Q 7/20

(52) U.S. Cl. 455/450

(57) ABSTRACT

A device transmits data via a wireless network. The device selects a wireless network from a group of wireless networks via which to transmit the data and transmits the data via the selected wireless network.

### FIELD OF THE INVENTION

Implementations consistent with the principles of the invention relate generally to communications networks and, more particularly, to systems and methods for transmitting data in a wireless communications network.

### BACKGROUND OF THE INVENTION

Cellular telephony systems have existed for well over a decade. A movement in recent years is to provide wireless Internet access (both in corporate settings and as “hot spots” within cities) in addition to conventional cellular telephony service. A number of wireless data networks currently exist to allow users to send and receive e-mails, access the Internet, perform two-way messaging, etc. Two such wireless networks include wireless fidelity (also known as “Wi-Fi”) networks and ReFLEX networks. As one skilled in the art will appreciate, Wi-Fi networks provide higher throughput as compared to ReFLEX networks.

Currently, wireless devices may be configured to communicate via a single wireless network. For example, if a wireless device is configured to communicate via a Wi-Fi network, then the wireless device may connect to and communicate via the Wi-Fi network any time that the wireless device is within a Wi-Fi hot spot. If the Wi-Fi network is not available, the wireless device may not communicate with other devices, even in those situations where the wireless device is located within a ReFLEX hot spot.

Therefore, there exists a need for systems and methods that allow a wireless device to select the wireless network with which it wishes to connect.

### SUMMARY OF THE INVENTION

In an implementation consistent with the principles of the invention, a device includes a wireless transceiver, and logic that may determine whether a first network is available for transmitting data, transmit the data to the first network using the wireless transceiver when the first network is available, determine, when the first network is determined to be unavailable, whether a second network is available, where the second network is different than the first network, and transmit the data to the second network using the wireless transceiver when the second network is available.

In another implementation consistent with the principles of the invention, a method for transmitting data is provided. The method may include selecting a wireless network from a group of wireless networks via which to transmit the data, and transmitting the data via the selected wireless network.

In still another implementation consistent with the principles of the invention, a device includes logic that may select a network from a group of networks. Each network in the group of networks uses at least one of a different frequency and a different communication protocol. The device also includes a transceiver that may transmit data via the selected network.

### BRIEF DESCRIPTION OF THE DRAWINGS

The accompanying drawings, which are incorporated in and constitute a part of this specification, illustrate an embodiment of the invention and, together with the description, explain the invention. In the drawings,

FIG. 1 illustrates an exemplary system in which systems and methods, consistent with the principles of the invention, may be implemented;

FIG. 2 illustrates an exemplary configuration of the wireless device of FIG. 1 in an implementation consistent with the principles of the invention;

FIG. 3 illustrates an exemplary configuration of the network operations center of FIG. 1 in an implementation consistent with the principles of the invention;

FIG. 4 illustrates an exemplary process, consistent with the principles of the invention, that may be performed by a wireless device when the wireless device in an implementation consistent with the principles of the invention;

FIG. 5 illustrates an exemplary process for transmitting data from a wireless device in an implementation consistent with the principles of the invention;

FIG. 6 illustrates an exemplary process that may be performed by a network operations center in an implementation consistent with the principles of the invention; and

FIG. 7 illustrates an exemplary process that may be performed by a device tracker in an implementation consistent with the principles of the invention.

### DETAILED DESCRIPTION

The following detailed description of implementations consistent with the principles of the invention refers to the accompanying drawings. The same reference numbers in different drawings may identify the same or similar elements. Also, the following detailed description does not limit the invention. Instead, the scope of the invention is defined by the appended claims and their equivalents.

A wireless communication device, consistent with the principles of the invention, is capable of transmitting data via a number of different protocols. In one implementation, when data is to be transmitted from the wireless device, the wireless device may attempt to transmit the data using a first communication protocol. If the attempt fails, the wireless device may attempt to transmit the data using a second communication protocol. If that attempt also fails, the wireless device may queue the data for later transmission using the first or second communication protocol.

### Exemplary System

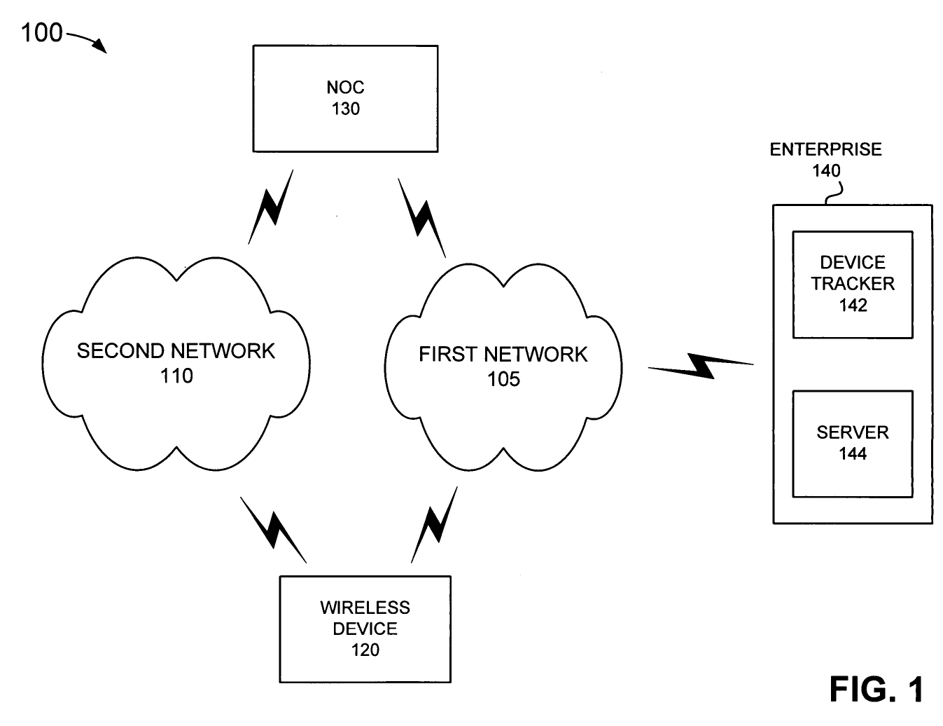

FIG. 1 illustrates an exemplary system 100 in which systems and methods, consistent with the principles of the invention, may be implemented. As illustrated, system 100 may include a first wireless network 105, a second wireless network 110, a wireless device 120, a network operations center (NOC) 130, and an enterprise 140. The number of devices illustrated in FIG. 1 is provided for simplicity. In practice, a typical system could include more or fewer devices than illustrated in FIG. 1.

Network 105 may include a wireless network, having a first communication protocol, that is capable of forwarding data towards its proper destination. In one implementation, network 105 includes an IEEE 802.11-compatible wireless data network, also known as a “Wi-Fi” network. Network 110 may include a wireless network, having a second, different communication protocol, that is capable of forwarding data towards its proper destination. In one implementation, network 110 includes a wireless data network utilizing the ReFLEX protocol. It will be appreciated that network 105 and network 110 may include other types of networks. For example, network 105 and/or network 110 may include a wireless data network as well as a wired (or optical) network. For explanatory purposes, it is assumed hereinafter that network 105 and network 110 use disparate frequencies, protocols, and/or modulation methods.

Wireless device 120 may include a device capable of transmitting data and/or voice signals to a wireless network, such as networks 105 and 110. In one implementation, wireless device 120 may include a radiotelephone with or without a multi-line display; a Personal Communications System (PCS) terminal that may combine a cellular radiotelephone with data processing, facsimile, and data communications capabilities; a Personal Digital Assistant (PDA) that can include a radiotelephone, a pager, an Internet/intranet access, a Web browser, an organizer, a calendar, and/or a global positioning system (GPS); and a conventional laptop and/or palmtop receiver or other appliance that includes a wireless transceiver. Wireless device 120 may be referred to as a “pervasive computing” device in some implementations consistent with the principles of the invention. In one implementation, wireless device 120 may have the capability to transmit/receive e-mail, perform two-way messaging, Voice-Over-Internet Protocol (VoIP) communications, push-to-talk communications, and/or virtual private network (VPN) communications, and/or transmit/receive data from the Internet or another data network.

Network operations center 130 may include any type of computer system, such as a mainframe, minicomputer, personal computer, laptop, personal digital assistant, or the like, capable of connecting to networks 105 and 110. In one implementation consistent with the principles of the invention, network operations center 130 may include a virtual router that receives traffic from network devices (e.g., an Internet server, an enterprise server, a wireless device, etc.) and transfers the traffic to wireless device 120. The traffic may include, for example, Hypertext Transfer Protocol (HTTP) data, Simple Mail Transfer Protocol (SMTP) data, Wireless Communications Transfer Protocol (WCTP) data, data from an Integrated Voice Response (IVR) unit, or the like. The network operations center 130 may also receive traffic from wireless device 120 and transfer the traffic towards its appropriate destination.

Enterprise 140 may include a privately owned and maintained network. As illustrated, enterprise 140 may include a device tracker 142 and a server 144. In those situations where wireless device 120 is associated with enterprise 140, device tracker 142 may track the location (or presence) of wireless device 120 in networks 105 and 110. Server 144 may include a network device that stores data to which wireless device 120 may desire access. For example, server 144 may include an e-mail server.

### Exemplary Wireless Device Configuration

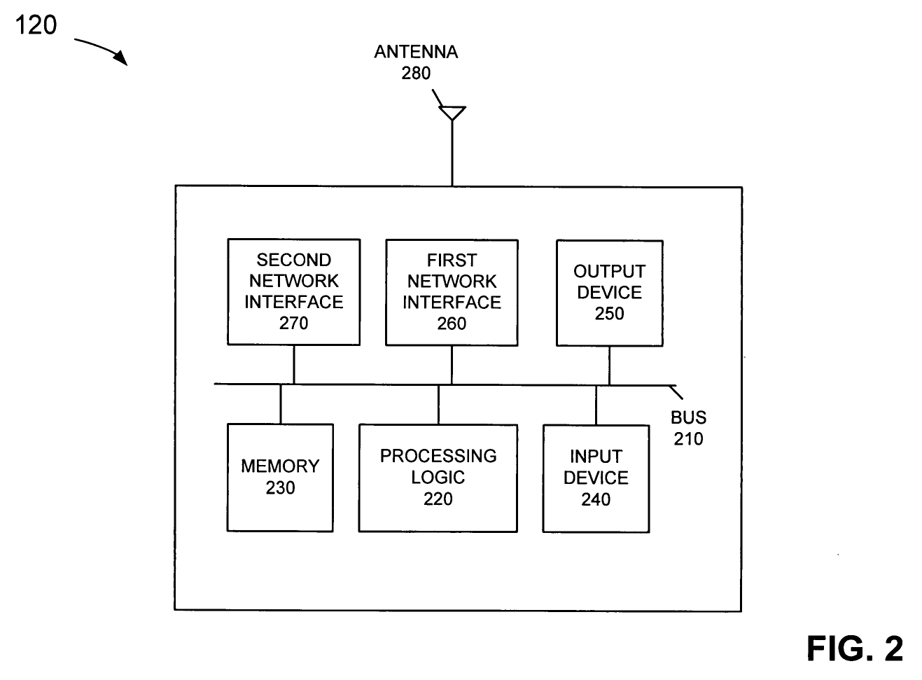

FIG. 2 illustrates an exemplary configuration of wireless device 120 in an implementation consistent with the principles of the invention. As illustrated, wireless device 120 may include a bus 210, processing logic 220, a memory 230, an input device 240, an output device 250, a first network interface 260, a second network interface 270, and an antenna 280. It will be appreciated that wireless device 120 may include other components (not shown) that aid in receiving, transmitting, and/or processing data.

Bus 210 may include a conventional bus that allows communication among the components of wireless device 120. Processing logic 220 may include any type of conventional processor or microprocessor that interprets and executes instructions. In other implementations, processing logic 220 may be implemented as an application specific integrated circuit (ASIC), field programmable gate array (FPGA), or the like. Memory 230 may include a random access memory (RAM) or another type of dynamic storage device that stores information and instructions for execution by processing logic 220; a read only memory (ROM) or another type of static storage device that stores static information and instructions for use by processing logic 220; and/or some type of magnetic or optical recording medium and its corresponding drive.

Input device 240 may include a conventional device that permits an operator to input information to wireless device 120, such as a keyboard, keypad, a mouse, a pen, a microphone, one or more biometric mechanisms, and the like. Output device 250 may include a conventional device that outputs information to the operator, including a display, a printer, a speaker, etc.

First network interface 260 may include any transceiver-like mechanism that enables wireless device 120 to communicate via network 105. In one implementation, first network interface 260 may include a transceiver or transmitter/receiver pair capable of transmitting and receiving data using an IEEE 802.11 protocol. Second network interface 270 may include any transceiver-like mechanism that enables wireless device 120 to communicate via network 110. In one implementation, second network interface 270 may include a transceiver or transmitter/receiver pair capable of transmitting and receiving data using the ReFLEX protocol. Although shown as two separate components, first network interface 260 and second network interface 270 may be implemented as a single component in other implementations consistent with the principles of the invention. Antenna 280 may include any directional, multi-directional, or omni-directional antenna or antenna array.

Wireless device 220 may implement the functions described below in response to processing logic 220 executing software instructions contained in a computer-readable medium, such as memory 230. A computer-readable medium may be defined as one or more memory devices and/or carrier waves. In alternative embodiments, hardwired circuitry may be used in place of or in combination with software instructions to implement features consistent with the principles of the invention. Thus, implementations consistent with the present invention are not limited to any specific combination of hardware circuitry and software.

### Exemplary Network Operations Center Configuration

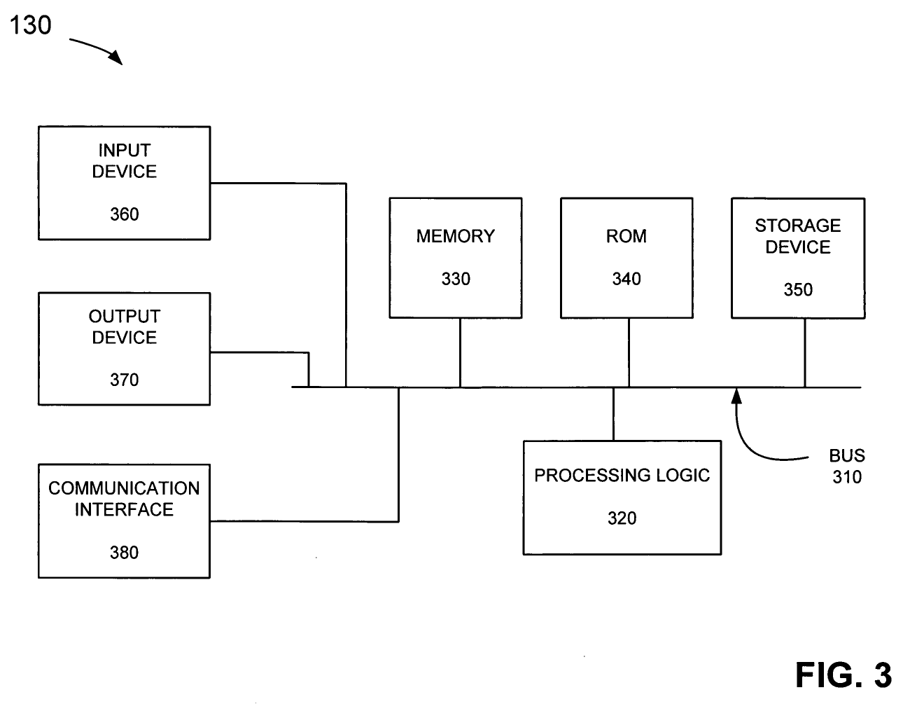

FIG. 3 illustrates an exemplary configuration of network operations center 130 in an implementation consistent with the principles of the invention. As illustrated, network operations center 130 may include a bus 310, processing logic 320, a memory 330, a ROM 340, a storage device 350, an input device 360, an output device 370, and a communication interface 380. Bus 310 permits communication among the components of network operations center 130.

Processing logic 320 may include any type of conventional processor or microprocessor that interprets and executes instructions. In alternative implementations, processing logic 320 may be implemented as an ASIC, FPGA, or the like. Memory 330 may include a RAM or another type of dynamic storage device that stores information and instructions for execution by processing logic 320. Memory 330 may also be used to store temporary variables or other intermediate information during execution of instructions by processing logic 320.

ROM 340 may include a conventional ROM device and/or another type of static storage device that stores static information and instructions for processing logic 320. Storage device 350 may include a magnetic disk or optical disk and its corresponding drive and/or some other type of magnetic or optical recording medium and its corresponding drive for storing information and instructions.

Input device 360 may include a conventional mechanism that permits an operator to input information to network operations center 130, such as a keyboard, pointing device (e.g., a mouse, a pen, or the like), a biometric mechanism, such as a voice recognition device, etc. Output device 370 may include a conventional mechanism that outputs information to the operator, such as a display, a printer, a speaker, etc. Communication interface 380 may include any transceiver-like mechanism that enables network operations center 130 to communicate with other devices and/or systems. For example, communication interface 380 may include a modem or an Ethernet interface to a network. Alternatively, communication interface 380 may include other mechanisms for communicating via a wireless data network, such as networks 105 and 110.

Network operations center 130 may implement the functions described below in response to processing logic 320 executing software instructions contained in a computer-readable medium, such as memory 330. In alternative embodiments, hardwired circuitry may be used in place of or in combination with software instructions to implement features consistent with the principles of the invention. Thus, implementations consistent with the present invention are not limited to any specific combination of hardware circuitry and software.

### Exemplary Processing

Implementations consistent with the principles of the invention allow a wireless device to determine, based, for example, on radio frequency conditions and network availability, to route data by two or more different routes and protocols. For explanatory purposes, it is assumed hereafter that wireless device 120 may transmit data via a ReFLEX network or a Wi-Fi network (i.e., an IEEE 802.11-based network).

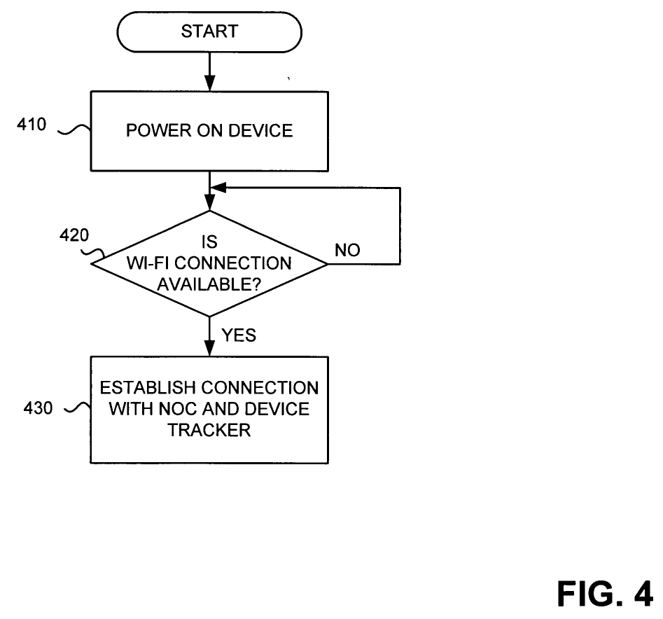

FIG. 4 illustrates an exemplary process that may be performed by a wireless device in an implementation consistent with the principles of the invention. Processing may begin with wireless device 120 being powered on (act 410). Wireless device 120 may determine whether a Wi-Fi connection is available (act 420). Wireless device 120 may make this determination automatically or in response to a command from a user of wireless device 120. As set forth above, wireless device 120 may, for example, determine whether a Wi-Fi connection is available by exchanging control signaling with an access point in the area in which wireless device 120 is located.

If no Wi-Fi connection is available, wireless device 120 may automatically reattempt establishing a Wi-Fi connection at periodic intervals. If, on the other hand, a Wi-Fi connection is available, wireless device 120 may establish a connection to network operations center 130 (act 430). In those situations where wireless device 120 is associated with an enterprise, such as enterprise 140, wireless device 120 may also establish a connection to device tracker 142 associated with enterprise 140 (act 430). These connections may remain until wireless device 120 loses its connection to the Wi-Fi network or until the connection to the Wi-Fi network is terminated. In this way, network operations center 130 and device tracker 142 may use the presence of these connections to instantly determine if wireless device 120 is in Wi-Fi coverage. If wireless device 120 loses its connection to the Wi-Fi network (e.g., by moving out of a Wi-Fi coverage area) and later re-enters a Wi-Fi coverage area, wireless device 120 may attempt to re-establish its connection to network operations center 130 and device tracker 142. It will be appreciated that wireless device 120 may also establish a connection with the REFLEX network (e.g., by registering with the REFLEX network) anytime that the REFLEX network is available.

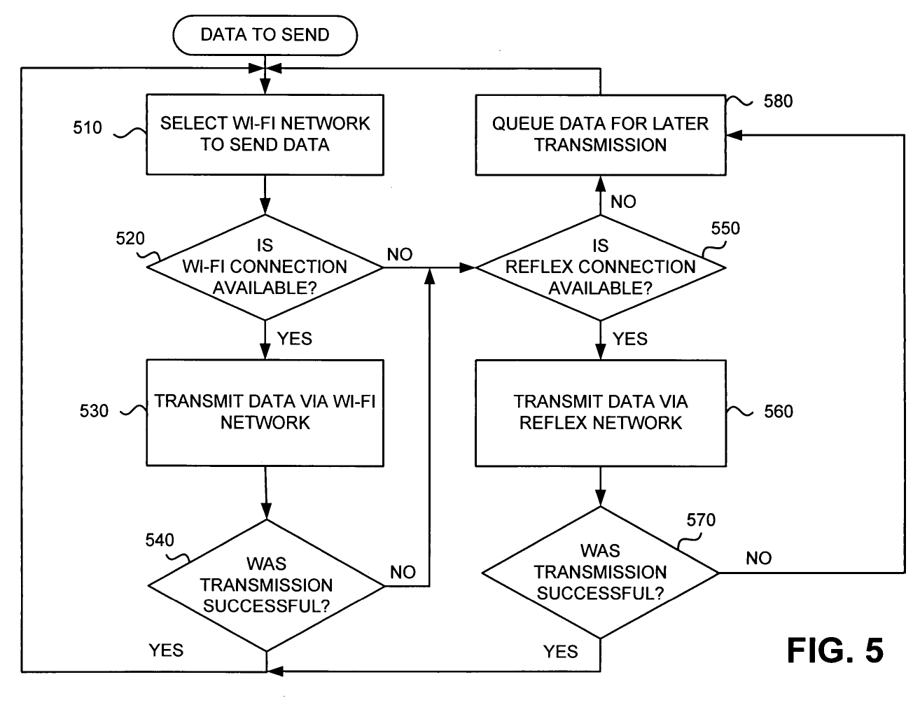

FIG. 5 illustrates an exemplary process for transmitting data from wireless device 120 in an implementation consistent with the principles of the invention. Processing may begin with wireless device 120 having data to transmit. Wireless device 120 may select an interface via which to transmit the data (act 510). In one implementation, wireless device 120 may automatically select the interface associated the Wi-Fi network in each instance when data is ready to be transmitted. This may be due, for example, to the increased throughput of a Wi-Fi network (e.g., 10 Mbps) as compared to a ReFLEX network (e.g., 6400/9600 bps).

Wireless device 120 may determine whether a Wi-Fi connection is available (act 520). Wireless device 120 may determine that a Wi-Fi connection is available in a conventional manner (e.g., by exchanging control signals with an access point in the area in which wireless device 120 is located). If a Wi-Fi connection is available (act 520), wireless device 120 may transmit all or part of the data via the Wi-Fi connection (act 530). Wireless device 120 may transmit the data to network operations center 130 for forwarding to its intended destination or another network device (e.g., another wireless device 120, a network server, a device in enterprise 140, or the like). If the transmission of the data via the Wi-Fi connection is successful (act 540), processing may return to act 510 when wireless device 120 has new data to transmit.

If wireless device 120 determines that a Wi-Fi connection is not available (act 520) or the transmission of data via an available Wi-Fi connection was unsuccessful (act 540), wireless device 120 may determine whether a ReFLEX connection is available (act 550). Wireless device 120 may determine whether a ReFLEX connection is available in a conventional manner (e.g., by exchanging control signals with a base station in the area in which wireless device 120 is located). If a ReFLEX connection is available (act 550), wireless device 120 may transmit all or part of the data via the ReFLEX connection (act 560). When transmitting via the ReFLEX connection, wireless device 120 may transmit the data to network operations center 130 (or other device) for forwarding to its intended destination. In one implementation, wireless device 120 may send an abbreviated portion of the data to network operations center 130 when transmitting data via a ReFLEX connection due to the limited bandwidth of the ReFLEX connection. If the transmission of the data via the ReFLEX connection is successful (act 570), processing may return to act 510 when wireless device 120 has new data to transmit.

If wireless device 120 determines that a ReFLEX connection is not available (act 550) or the transmission of data via an available ReFLEX connection was unsuccessful (act 560), wireless device 120 may queue the data for later transmission when a network connection becomes available (act 580). Wireless device 120 may, for example, store the data in memory 230 (FIG. 2). Wireless device 120 may wait a configurable period of time and then processing may return to act 510 with wireless device 120 attempting to transmit the data again via a Wi-Fi connection.

In other implementations consistent with the principles of the invention, a user of wireless device 120 may select (or override a selection of) the network (i.e., ReFLEX or Wi-Fi) via which the data will be transmitted. The user may make the network selection via input device 240 (FIG. 2). In one implementation, wireless device 120 may provide the user with an indication (e.g., visually, audibly, etc.) of the availability of the Wi-Fi and ReFLEX networks.

Although not described above, the transmission of data from wireless device 120 may be made secure using any conventional encryption technique. For example, wireless device 120 may transmit data using secured socket layer (SSL) RSA 128-bit encryption key.

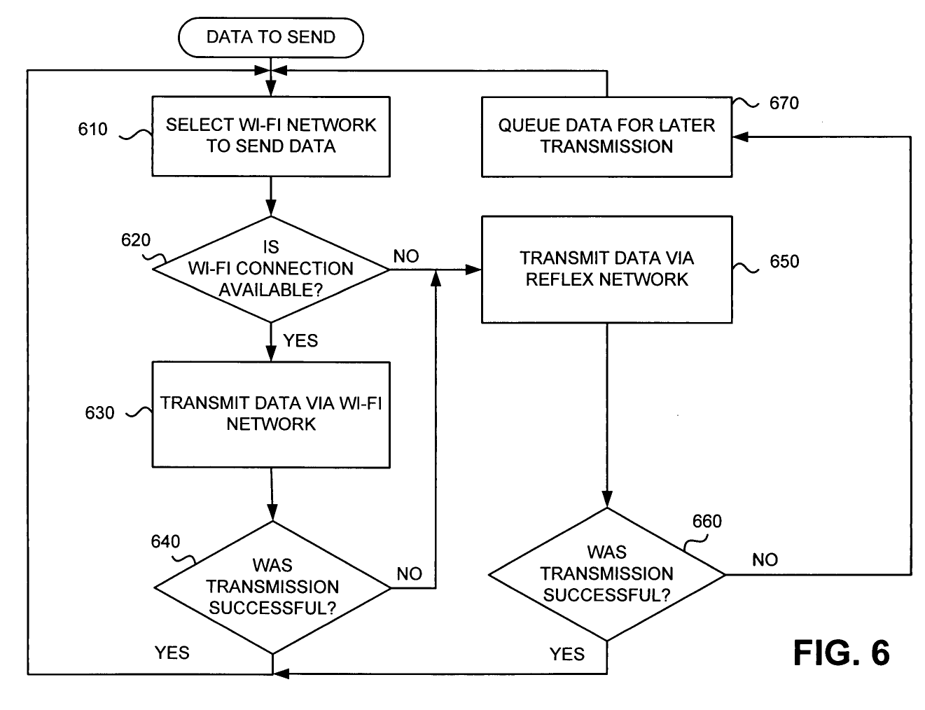

Transmission of data from network operations center 130 to wireless device 120 may be performed in a manner similar to that described above with respect to FIG. 5. FIG. 6 illustrates an exemplary process that may be performed by network operations center 130 in an implementation consistent with the principles of the invention. Processing may begin with network operations center 130 having data to transmit to wireless device 120. Network operations center 130 may select an interface via which to transmit the data (act 610). In one implementation, network operations center 130 may automatically select the interface associated the Wi-Fi network in each instance when data is ready to be transmitted. This may be due, for example, to the increased throughput of a Wi-Fi network (e.g., 10 Mbps) as compared to a ReFLEX network (e.g., 6400/9600 bps).

Network operations center 130 may determine whether a Wi-Fi connection is available (act 620). As set forth above, wireless device 120 may establish a connection to network operations center 130 every time that wireless device 120 is in Wi-Fi coverage. Therefore, network operations center 130 may use the presence of this connection to determine whether a Wi-Fi connection is available to wireless device 120. If a Wi-Fi connection is available (act 620), network operations center 130 may transmit all or part of the data to wireless device 120 via the Wi-Fi connection (act 630). If the transmission of the data via the Wi-Fi connection is successful (act 640), processing may return to act 610 when network operations center 130 has new data to transmit to wireless device 120.

If network operations center 130 determines that a Wi-Fi connection is not available to wireless device 120 (act 620) or the transmission of data via an available Wi-Fi connection was unsuccessful (act 640), network operations center 130 may attempt to transmit all or a portion of the data via a ReFLEX connection (act 650). In one implementation, network operations center 130 may send an abbreviated portion of the data to wireless device 120 when transmitting data via a ReFLEX connection due to the limited bandwidth of the ReFLEX connection. If the transmission of the data via the ReFLEX connection is successful (act 660), processing may return to act 610 when network operations center 130 has new data to transmit.

If the transmission of data to wireless device 120 over a ReFLEX connection was unsuccessful (e.g., due to wireless device 120 not being connected to the ReFLEX network) (act 660), network operations center 130 may queue the data for later transmission when a network connection becomes available (act 670). In this situation, network operations center 130 may, for example, store the data in memory 330 (FIG. 3). Network operations center 130 may wait a configurable period of time and then processing may return to act 610 with network operations center 130 attempting to transmit the data again via a Wi-Fi connection.

In one implementation consistent with the principles of the invention, network operations center 130 may choose to route data to wireless device 120 via the ReFLEX network instead of the Wi-Fi network (when connections are available to wireless device 120 via both networks) for cost purposes. For example, the cost of routing data via the ReFLEX network may be lower or fixed, while the cost of routing data via the Wi-Fi network may vary from geographic location to geographic location.

Although not described above, the transmission of data from network operations center 130 may be made secure using any conventional encryption technique. For example, network operations center 130 may transmit data using secured socket layer (SSL) RSA 128-bit encryption key.

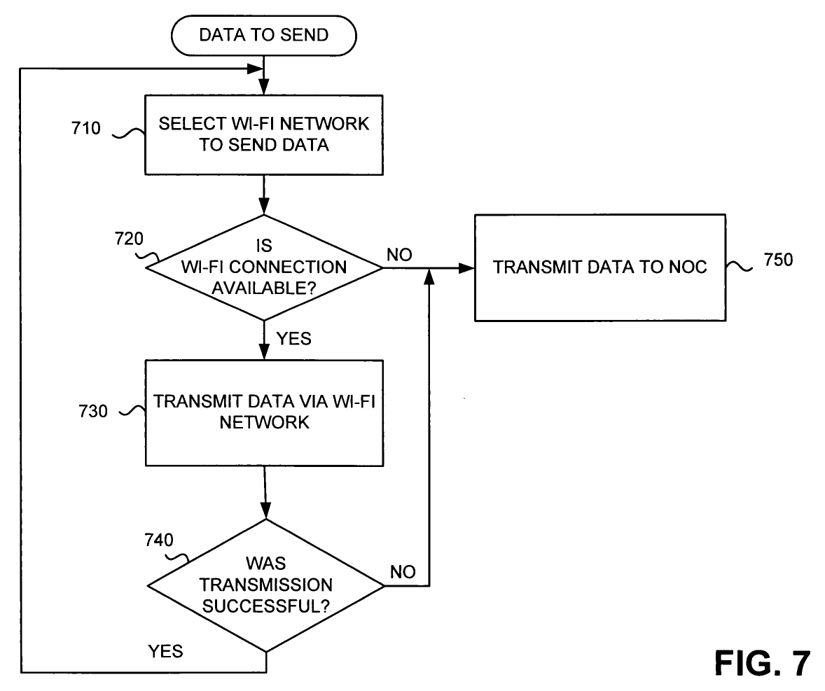

As illustrated in FIG. 1, system 100 may include an enterprise 140 with which wireless device 120 may be associated. FIG. 7 illustrates an exemplary process that may be performed by device tracker 142 in an implementation consistent with the principles of the invention. Processing may begin with device tracker 142 having data to transmit to wireless device 120. Device tracker 142 may select an interface via which to transmit the data (act 710). In one implementation, device tracker 142 may automatically select the interface associated with the Wi-Fi network in each instance when data is ready to be transmitted. This may be due, for example, to the increased throughput of a Wi-Fi network (e.g., 10 Mbps) as compared to a ReFLEX network (e.g., 6400/9600 bps).

Device tracker 142 may determine whether a Wi-Fi connection is available (act 720). As set forth above, wireless device 120 may establish a connection to device tracker 142 every time that wireless device 120 is in Wi-Fi coverage. Therefore, device tracker 142 may use the presence of this connection to determine whether a Wi-Fi connection is available to wireless device 120. If a Wi-Fi connection is available (act 720), device tracker 142 may transmit all or part of the data to wireless device 120 via the Wi-Fi connection (act 730). If the transmission of the data via the Wi-Fi connection is successful (act 740), processing may return to act 710 when device tracker 142 has new data to transmit to wireless device 120.

If device tracker 142 determines that a Wi-Fi connection is not available to wireless device 120 (act 720) or the transmission of data via an available Wi-Fi connection was unsuccessful (act 740), device tracker 142 may transmit all or a portion of the data intended for wireless device 120 to network operations center 130 (act 750). Network operations center 130 may then forward the data to wireless device 120 in the manner described above with respect to FIG. 6. Alternatively, device tracker 142 may queue the data when a Wi-Fi connection is not available to wireless. Device tracker 142 may later re-attempt transmission when a Wi-Fi connection becomes available.

The transmission of data from device tracker 142 may be made secure using any conventional encryption technique. For example, device tracker 142 may transmit data using secured socket layer (SSL) RSA 128-bit encryption key.

### CONCLUSION

Implementations consistent with the principles of the invention allow a wireless device to decide, based, for example, on radio frequency conditions and network availability, to route data by two or more different routes and protocols.

The foregoing description of exemplary embodiments of the present invention provides illustration and description, but is not intended to be exhaustive or to limit the invention to the precise form disclosed. Modifications and variations are possible in light of the above teachings or may be acquired from practice of the invention. For example, while the above description focused on the selection between a Wi-Fi network and a ReFLEX network, implementations consistent with the principles of the invention are not so limited. In fact, implementations consistent with the principles of the invention are equally applicable to other types of wireless networks, using different frequencies, communication protocols and/or modulation techniques than Wi-Fi or ReFLEX networks. Moreover, while the above description focused on the selection between two disparate networks, implementations consistent with the principles of the invention are equally applicable to the selection between more than two disparate networks or between two or more similar types of networks.

While series of acts have been described with respect to FIGS. 4 and 5, the order of the acts may be varied in other implementations consistent with the invention. Moreover, non-dependent acts may be implemented in parallel.

In other implementations consistent with the principles of the invention, communications between enterprise 140 and wireless device 120 may not involve device tracker 142. That is, other devices within enterprise 140 may communicate with wireless device 120 in a manner similar to the process described above with respect to FIG. 7.

It will be apparent to one of ordinary skill in the art that aspects of the invention, as described above, may be implemented in many different forms of software, firmware, and hardware in the implementations illustrated in the figures. The actual software code or specialized control hardware used to implement aspects consistent with the principles of the invention is not limiting of the invention. Thus, the operation and behavior of the aspects of the invention were described without reference to the specific software code—it being understood that one of ordinary skill in the art would be able to design software and control hardware to implement the aspects based on the description herein.

Further, certain portions of the invention may be implemented as “logic” that performs one or more functions. This logic may include hardware, such as an application specific integrated circuit or a field programmable gate array, software, or a combination of hardware and software.

No element, act, or instruction used in the description of the present application should be construed as critical or essential to the invention unless explicitly described as such. Also, as used herein, the article “a” is intended to include one or more items. Where only one item is intended, the term “one” or similar language is used.

The scope of the invention is defined by the claims and their equivalents.

1. A device comprising:
a wireless transceiver; and
logic to:
determine whether a first network is available for transmitting data,
transmit the data to the first network using the wireless transceiver when the first network is available,
determine, when the first network is unavailable, whether a second network is available, the second network being different than the first network, and
transmit the data to the second network using the wireless transceiver when the second network is available.

2. The device of claim 1 wherein the first network comprises an IEEE 802.11-based network and the second network comprises a ReFLEX-based network.

3. The device of claim 1 wherein the logic is further configured to:
determine, when the first network is available, whether transmission of the data through the first network was successful, and
perform the determining whether the second network is available when the transmission of the data through the first network was unsuccessful.

4. The device of claim 3 wherein the logic is further configured to:
determine, when the second network is available, whether transmission of the data through the second network was successful, and
store the data when the transmission of the data through the second network was unsuccessful.

5. The device of claim 1 further comprising:
a memory, and
wherein the logic is configured to:
store the data in the memory for later transmission when the second network is determined to be unavailable.

6. The device of claim 1 wherein the wireless transceiver comprises:
a first wireless transceiver to transmit data to the first network, and
a second wireless transceiver to transmit data to the second network.

7. The device of claim 6 wherein the first wireless transceiver transmits data at a different frequency than the second wireless transceiver.

8. The device of claim 6 wherein the first wireless transceiver transmits data using a different communication protocol than the second wireless transceiver.

9. The device of claim 6 wherein the first wireless transceiver transmits data using a different modulation technique than the second wireless transceiver.

10. The device of claim 1 wherein the logic is further configured to:
establish a connection with an enterprise device when the first network is determined to be available.

11. The device of claim 1 wherein the logic is configured to:
determine whether the first network is available in response to the device being powered up.

12. The device of claim 1 wherein the logic is configured to:
determine whether the first network is available in response to the device having data to transmit.

13. A method for transmitting data, comprising:
selecting a wireless network from a group of wireless networks via which to transmit the data; and
transmitting the data via the selected wireless network.

14. The method of claim 13 further comprising:
determining, prior to the transmitting, whether the selected wireless network is available; and
transmitting the data via another wireless network in the group of wireless networks when the selected wireless network is unavailable.

15. The method of claim 13 further comprising:
storing the data when none of the wireless networks in the group of wireless networks is available.

16. The method of claim 13 further comprising:
providing an indication of availability of each wireless network in the group of wireless networks.

17. The method of claim 16 wherein the indication comprises an audio indication.

18. The method of claim 16 wherein the indication comprises a visual indication.

19. The method of claim 13 wherein the group of wireless networks comprises an IEEE 802.11-based network and a ReFLEX-based network.

20. The method of claim 13 wherein the selecting is performed automatically.

21. A device comprising:
means for selecting a network from a group of networks via which to transmit data, the selected network utilizing a different communication protocol than another network in the group of networks; and
means for transmitting data via a selected network.

22. A device comprising:
logic to select a network from a plurality of networks, each network in the plurality of networks utilizing at least one of a different frequency and a different communication protocol; and
a transceiver to transmit data via the selected network.

23. The device of claim 22 wherein the plurality of networks comprises an IEEE 802.11-based network and a ReFLEX-based network.

24. The device of claim 23 wherein the logic is configured to:
select the IEEE 802.11-based network to transmit data over the ReFLEX-based network when both networks are available.

25. The device of claim 23 further comprising:
logic to establish a connection with an enterprise device when the IEEE 802.11-based network is available.

26. The device of claim 22 wherein the transceiver comprises:
a transceiver for each network in the plurality of networks.

27. The device of claim 22 wherein the logic is configured to select the network automatically.

28. The device of claim 22 wherein the logic is configured to select the network in response to an input from a user.

29. The device of claim 22 wherein the logic performs the selecting when data is to be transmitted from the device.

30. The device of claim 22 further comprising:
logic configured to override the selection of the network.
